(19) United States
(12) Patent Application Publication
(10) Pub. No.: US 2020/0042672 A1
(43) Pub. Date: Feb. 6, 2020

(54) STATISTICAL MULTIPLEXING OF SOFTWARE LICENSES

(71) Applicant: Stratus Silver Lining, Inc., Sarasota, FL (US)

(72) Inventors: Suman Banerjee, Sarasota, FL (US); Alok Sharma, Madison, WI (US)

(73) Assignee: Stratus Silver Lining, Inc., Sarasota, FL (US)

(21) Appl. No.: 16/051,455

(22) Filed: Jul. 31, 2018

(51) Int. Cl. G06F 21/10; H04L 29/08

(52) U.S. Cl. CPC G06F 21/105; H04L 67/306; H04L 67/22

(57) ABSTRACT

A method includes estimating usage patterns of a plurality of users for a first software application in a computing system. A set of time conflicts is generated based on the usage patterns. A license count for the first software application is estimated based on the set of time conflicts. Additional licenses are secured for the first application in the computing system responsive to the estimated license count not being less than an actual license count by a predetermined margin.

### BACKGROUND

### Field of the Disclosure

The present disclosure relates generally to computing systems, and more particularly, to a method and system for statistical multiplexing of software licenses.

### Description of the Related Art

Computing networks are employed to connect multiple users to shared resources. However, conventional network approaches typically require an individual computer system for each user to execute the desired computing applications. In educational or workplace settings it is common for a bank of workstations to be provided to execute resource intensive applications, such as drawing programs, simulation programs, design automation programs, etc. Due to the high level of processing requirements, the workstations may need to be equipped with advanced processors, increased memory, specialized graphics hardware, etc. These processing demands limit the use of the programs outside the educational or workplace networks, as the computing devices used outside these networks (e.g., notebook computers or less powerful desktops) cannot effectively execute the advanced applications. In an educational setting, this arrangement makes it difficult to implement remote learning opportunities, as the remote students do not have access to the advanced workstations.

In some instances, an entity may maintain a limited number of licenses for a particular software application. A license server on the network may monitor the number of copies of the application in use at any particular moment in time and limit the number of active users according to the number of licenses owned. Hence, not all of the workstations in a facility may be able execute the licensed application, even if they have sufficient computing resources. In an educational setting, this restriction limits class sizes. The limitation also limits remote learning opportunities since the license server only facilitates license management for the workstations on the same network. If a user attempts to launch an application and the pool of licenses is exhausted, the launch will fail and the user will not be able to use the application.

### BRIEF DESCRIPTION OF THE DRAWINGS

The present disclosure may be better understood, and its numerous features and advantages made apparent to those skilled in the art, by referencing the accompanying drawings. The use of the same reference symbols in different drawings indicates similar or identical items.

FIG. 1 is a simplified block diagram of a cloud based virtual computing system, in accordance with some embodiments.

FIG. 2 is a simplified block diagram illustrating how the management server distributes software licenses across multiple users, in accordance with some embodiments.

FIG. 3 is a simplified block diagram of a license estimator employed by the management server, in accordance with some embodiments.

FIG. 4 is a diagram illustrating the operation of a requirements estimator in the license estimator of FIG. 3, in accordance with some embodiments.

FIGS. 5 and 6 are diagrams illustrating the operation of a license count estimator in the license estimator of FIG. 3, in accordance with some embodiments.

FIG. 7 is a flow diagram of a method for statistical multiplexing of software licenses, in accordance with some embodiments.

### DETAILED DESCRIPTION

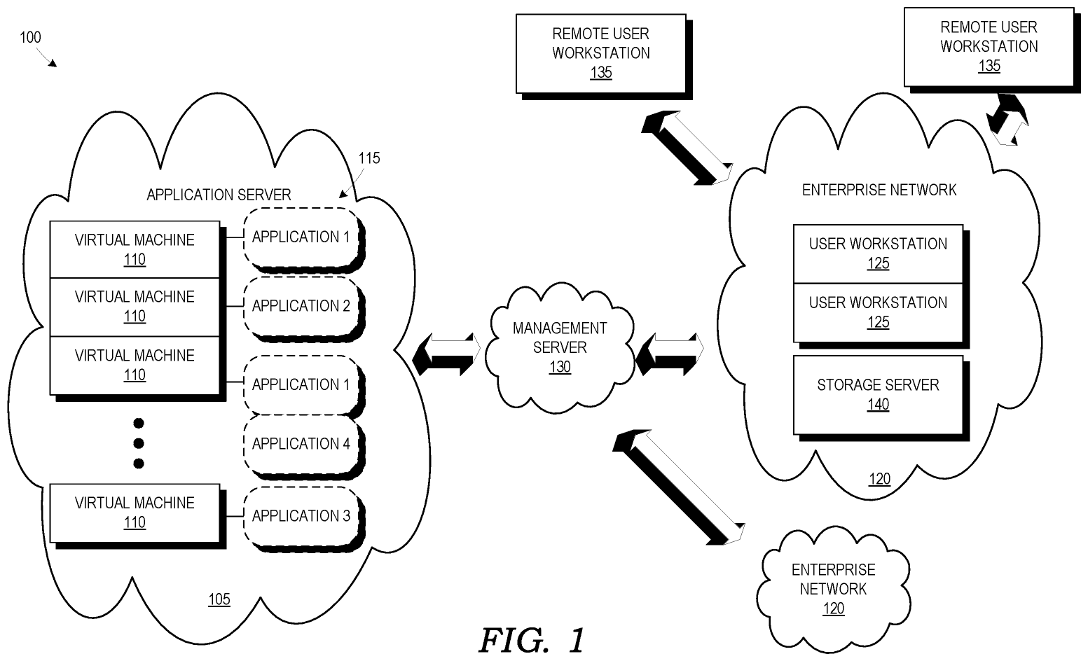

FIGS. 1-7 illustrate a cloud based virtual computing system with that implements statistical multiplexing of software licenses. In the illustrated examples, virtual workstations may be implemented using a cloud based virtualization system, where users can access advanced applications on virtual machines in the cloud using a remote terminal application. The user may interact with advanced application as if a local advanced workstation were being used, but the advanced processing requirements for the application may be handled by the virtualization system. A management server implements a license estimator to estate temporal factors and license requirement factors for the required licenses and generate an estimate of the licenses required for the virtual computing system.

FIG. 1 is a simplified block diagram of a cloud based virtual computing system 100 in accordance with some embodiments. The system 100 includes an application server 105 operable to support the virtualization of a plurality of virtual machines 110. As known to those of ordinary skill in the art, machine virtualization involves dividing the computing resources of a physical processing unit or units into multiple virtual machines 110, each with its own operating system, software applications, virtual processor, memory, peripheral devices, etc. The virtualization resource allocates physical computing resources from a pool of computing systems, such as severs, to meet the processing demands of the individual virtual machines 110. Commercial application servers 105 that enable the use of virtual machines are AZURE® by MICROSOFT® and Amazon Web Services (AWS) by AMAZON®.

In the illustrated embodiment, the virtual machines 110 are employed to execute one or more applications 115 (e.g., Applications 1 . . . N). The applications 115 may represent software applications that have relatively high processing requirements, such that it would typically requires the use of a relatively high powered computing system for its execution. For example, one such application is MATLAB®. However, the application of the subject matter disclosed herein is not limited to a particular software application.

The system 100 also includes one or more enterprise networks 120, each including a plurality of user workstations 125. In the illustrated embodiment, the user workstations 125 act as terminals for interacting with the virtual machines 110 to allow operation of the applications 115. The use of the virtual machines 110 reduces the constraints on the processing power required for the user workstations 125.

A management server 130 interfaces between the user workstations 125 and the virtual machines 110. Communications may take place through the Internet using a remote terminal protocol, such as a remote desktop protocol (RDP). In some embodiments, the enterprise network 120 may support remote user workstations 135 that connect to the enterprise network 120 via secure protocols, such as virtual private network (VPN) connections, and subsequently connect through the enterprise network 120 and the management server 130 to one of the virtual machines 110. In this manner, users may be centrally located at a facility within the enterprise network 120 or they may be dispersed geographically. Such an arrangement supports distance learning for an educational institution or telecommuting for a business.

Each enterprise network 120 may also include a storage server 140 for storing user data, such as data files, or report files associated with the applications 115. In some embodiments, the workstations 125, 135 may have local storage (e.g., drives) for storing the data in conjunction with or in lieu of the storage server 140. The term local storage, as used herein is intended to imply local to the enterprise network 120 or the terminals 125, 135, as compared to any remote storage provided by the application server 105.

The system 100 allows allow each user to have a separate virtual machine 110 that can be accessed using private credentials (username and password). In the course of operating the user generates various types of code and data (e.g., code related to the process the user wants to run and the output from running such code on various inputs).

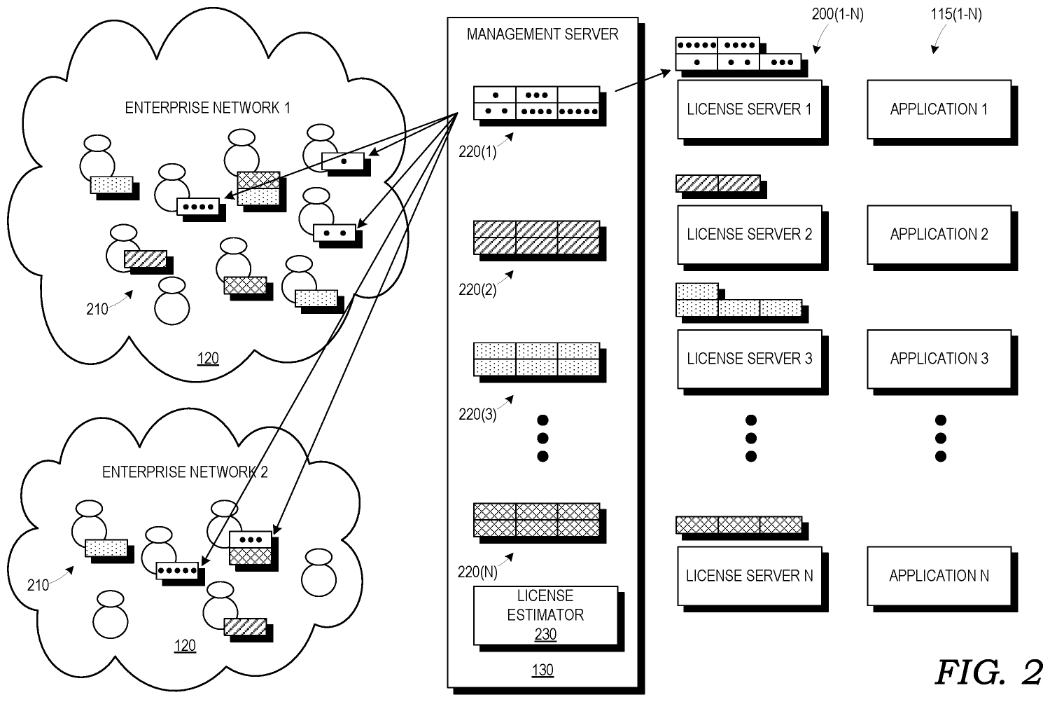

FIG. 2 is a simplified block diagram illustrating how the management server 130 distributes software licenses across multiple users in accordance with some embodiments. The management server 130 handles licenses for applications 115(1)-115(N). Each application 115 has an associated license server 200(1)-200(N) (e.g., that may be operated by the maker of the associated application 115). The management server 130 may manage licenses for multiple organizations, such as enterprise networks 120(1), 120(2). Each of the enterprise networks 120 has a set of users 210 that may execute the applications 115. Licenses 220(1)-220(N) for the different applications 115 are represented as blocks with different shading. In general, when a user 210 executes an application 115, the management server 130 registers an active license with the appropriate license server 200 and assigns the license to the user 210, as represented by arrows in FIG. 2. For ease of illustration, arrows are only shown for Application 1. One user 210 may employ licenses 220 for multiple applications 115. Dots are provided in the licenses 220(1) to show the correspondence between the licenses 220(1) allocated to the users 210 and registered with the license server 220. If the supply of available licenses 200 for a particular application 115 is exhausted, the management server 130 prohibits an additional user from executing the associated application 115. The management server 130 may send a denial message to the affected user. At some later time, the management server 130 may send another message to the user

The operator of the management server 130 (e.g., distributor independent of application maker or operators of enterprise networks 120) contracts to provide access to a specific set of applications 115 to an organization operating the enterprise network 120. The organization may specify a specific count of licenses 220 for each of the various available applications 115.

The users 210 in the enterprise networks 120 may be members of a single organization under a single administrative control (e.g., a company or university) or subunits within an organization.

The license servers 200 ensures only that a single instance of a specific license for a particular application 115 is allocated at any given time. The management server 130 can dynamically re-assign a license 220 surrendered by one user 210 to another user 210 (i.e., either belonging to the same or different organizations). In this manner, a single license 220 can be shared by multiple users 210 provided they do not need the license at the same time.

However, the management server 130 does not obtain enough licenses such that all contracted licenses 220 for all organizations 120 can be allocated at the same time, as this would be economically inefficient. For example, if the organization associated with the enterprise network 120(1) contracts for 10 licenses 220(1) of Application 1, and the organization associated with the enterprise network 120(2) contracts for 5 licenses 220(1) of Application 1, the management server 130 would not have 15 total licenses 220(1) for allocation, but rather, some number less than the total to reduce the cost associated with the licenses 220(1). To manage the number of licenses 220(1), the management server 130 employs a license estimator 230.

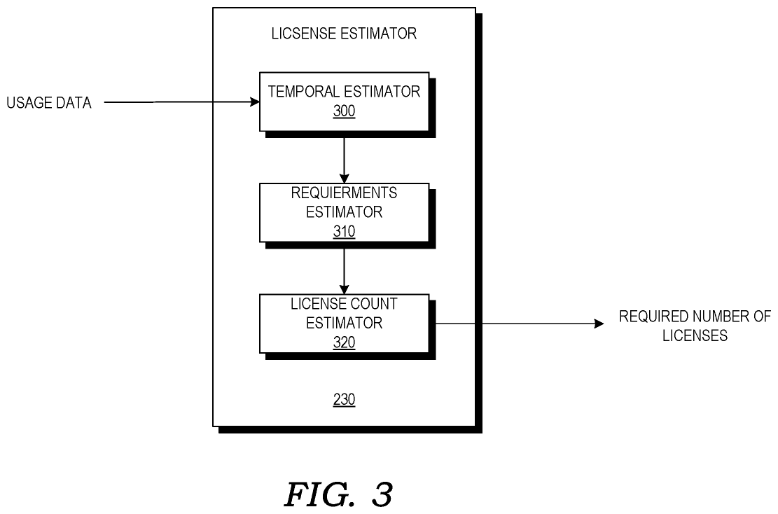

FIG. 3 is a simplified block diagram of the license estimator 230 employed by the management server 130, in accordance with some embodiments. The license estimator 230 includes a temporal estimator 300, a requirements estimator 310, and a license count estimator 320.

At a high level, the temporal estimator 300 is a machine learning based module that predicts the demand for each user 210 for various application 115 in terms of time of day and duration of use. In other words, the temporal estimator 300 will predict for a particular application 115, a particular user ID, and a time of day, whether the particular user 210 will need the license for the particular application 115 at that given time period, and if so, for how long. The temporal estimator 300 mines prior application usage information of each user 210 using various data analysis, machine learning, and statistical analysis techniques to estimate the temporal usage characteristics of every user 210.

The requirements estimator 310 is a module that combines information regarding the expected application usage of individual users 210 (as determined by the temporal estimator 300) with constraints dictated by the application maker, government law or regulation, etc., that restrict sharing of application licenses 220 between different users 210.

The license count estimator 320 is a module that estimates an overall number of licenses 220 required for a given application as determined by the requirements estimator 310 over a period of time and then determines a minimal number of licenses 220 that the operator of the management server 130 should maintain for each application 115, thereby allowing flexibility for multiplexing licenses, while still providing at any given point in time availability of the applications 115 to the users 210.

The goal of the temporal estimator 300 is to receive a user id, application ID, and a particular time of day as an inputs and predict the duration for which the user is going to use the application 115. The temporal estimator 300 returns a value of 0 if the user 210 is not expected to use the application 115 at the particular time.

In some embodiments, the temporal estimator 300 has two phases. A first phase, called a bootstrap phase, is initiated when a new user 210 belonging to a subscribing organization is enrolled with the management server 130. The goal of the bootstrap phase is to estimate the new user's requirements by looking at the usage pattern of other users 210 that have similar characteristics to the new user 210.

The temporal estimator 300 attempts to map the profile of the new user 210 to a specific persona (of application-specific usage) based on initial features of the profile collected at the time of registration. Examples of such characteristics include present place of work (or studies), job role (degree enrolled), years of experience (year of study), etc. The temporal estimator 300 returns a statistical temporal model of estimated application usage of the persona to which the new user 210 was mapped.

The general set of personas is created and customized by mining the entire historical data of application usage of all prior users 210 collected by the management server 130 using machine learning algorithms. To mine the historical data, machine learning algorithms such as Hidden Markov Model (HMM), support vector machine (SVM), clustering, frequent itemset mining, PCA, convolutional neural networks, a combination of such algorithms, etc., may be employed. In the event the new user maps to more than one persona, an aggregate of the multiple personas may be constructed (e.g., average).

Once, the new user 210 starts using various applications 115, the temporal estimator 300 enters a steady phase, wherein, it adapts the previously selected generic temporal estimator model based on the actual usage patterns of the user 210.

As mentioned earlier, the goal of requirements estimator 310 is to combine information regarding the expected application usage of individual users 210 as determined by the temporal estimator 300 with various policy constraints that may disallow sharing of licenses 220 among any subsets of the users 210.

The various policy constraints considered can arise from legal requirements of the organization, such as, but not limited to, not allowing their own users 210 to share a license 220 with users 220 of another organization. In some instances the organization may disallow sharing of licenses 220 between users 210 belonging to same organization, but to different business units or different geographies.

The application maker might also place similar constraints on reuse of licenses 220 across multiple geographies or business, etc.

Restrictions will mostly occur due to two users 210 needing access to the same application 115 at same point in time. As mentioned above, the maker of application will allow only one active copy of a unique license 220 at any given point of time. Hence, if the temporal estimator 300 determines that the requirement for license 220 by two users 210 might intersect in time, the two users 210 will not be able to share a license 220.

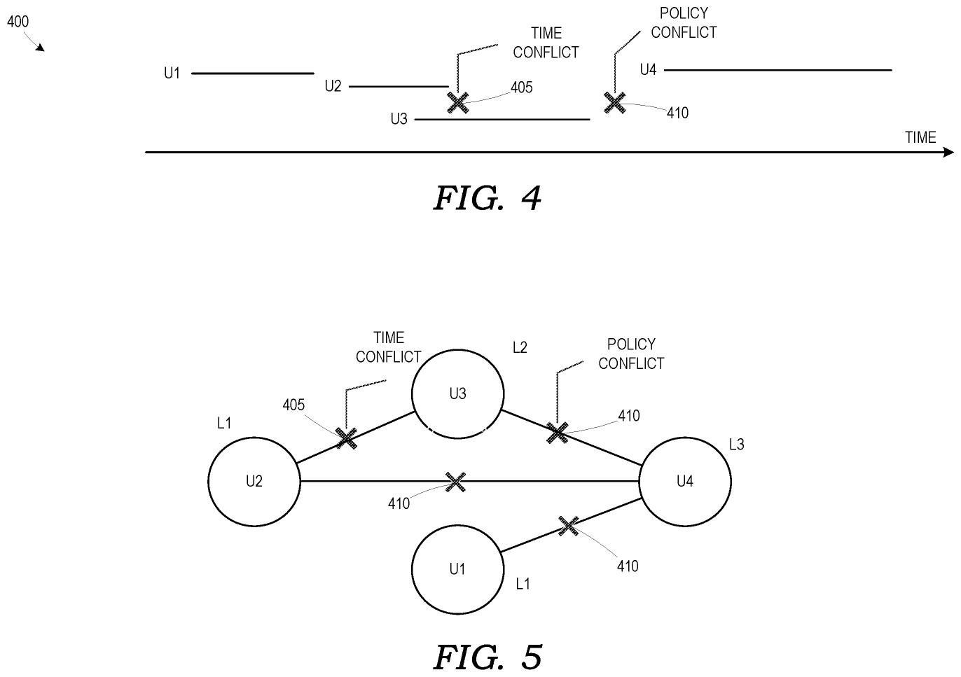

FIG. 4 is a diagram illustrating the operation of the requirements estimator 310, in accordance with some embodiments. The temporal estimator 300 (or the requirements estimator 310) creates a timeline 400 for each application 115 from data generated by the temporal estimator 300. For a given time window (e.g., hour, day, week, month, etc.) an interval U1-U4 on the timeline 400 corresponds to a user with predicted usage of the specific application 115 within the time window.

For purposes of illustration, assume that the users U1, U2, U3 belong to one organization, the user U4 belongs to a second organization, and a license-sharing restriction is in place disallowing license sharing across the two organizations. A time conflict situation arises if the temporal estimator 300 predicts that the two users will simultaneously require access to the same application 115 during the time window. A policy conflict arises if the usage pattern conflicts with a license-sharing restriction. The requirements estimator 300 analyzes the expected application usage timeline 400 to identify time and policy conflicts.

As seen in FIG. 4, users U1 and U2 may share a license because their predicted usage intervals do not overlap within the time window. In contrast, users U2 and U3 may not share a license due to their overlapping usage intervals within the time window, thereby giving rise to a time conflict 405. Although the predicted usage intervals for users U1-U3 and U4 do not overlap (i.e., no time conflict), since users U1-U3 and U4 are from different organizations, a policy conflict 410 arises. The policy conflict 410 arises between each of users U1, U2, and U3, and user U4, but only one conflict mark is shown.

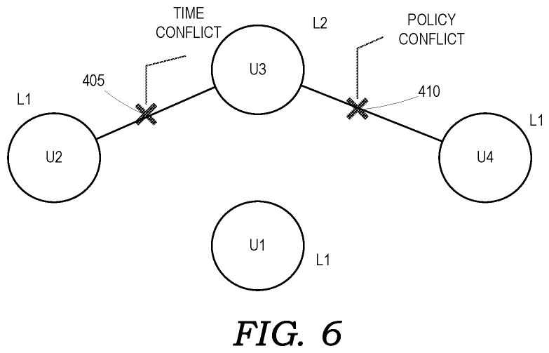

FIGS. 5 and 6 are diagrams illustrating the operation of the license count estimator 320, in accordance with some embodiments. In general, the license count estimator 320 determines the number of licenses 220 for a particular application 115 required within a given time window. The license count estimator 320 leverages the adjusted timeline 400 output by the requirements estimator 310 to determine the required number of licenses 220. The license count estimator 320 generates a usage graph 500 (illustrated as being graphical in nature, but not required to be graphical). Each vertex on the usage graph 500 corresponds to a user, U1-U4. The license count estimator 320 assigns licenses (designated as L1 . . . LN) to the users at each vertex, taking into consideration the time conflicts 405 and policy conflicts 410 identified by the requirements estimator 310. Two vertices are connected (i.e. designated as being adjacent) if a usage or policy conflict is identified between the users. A license may not be shared by adjacent vertices.

The license count estimator 320 assigns license L1 to user U1. Because no conflicts occur between users U1 and U2, the license L1 may be shared, and the license count estimator 320 assigns license L1 to user U2. Since the vertices for users U2 and U3 are connected due to the time conflict 405, the license L1 may not be shared, and the license count estimator 320 assigns license L2 to U3. Since a policy conflict occurs between users U1-U3 and user U4, the licenses L1 and L2 cannot be shared, so the license count estimator 320 assigns license L3 to user U4. In the example of FIG. 5, the predicted license count is 3.

In general, the license count estimator 320 count the minimum number of unique license numbers required so that each vertex is assigned a license and adjacent vertices do not have same license number. This general concepts is referred to as determining the chromatic number of a graph.

FIG. 6 illustrates the operation of the license count estimator 320 under different assumptions. Assume that the policy conflict only exists between users U3 and U4. Is this instance, the vertex for user U4 is no longer adjacent the vertices for users U1 and U2. As a result, the license L1 may be shared with user U4, and the predicted license count becomes 2.

The license estimator 230 compares the predicted license alerts the management server 130 when the predicted license count is greater than or within a predetermined range of the number of licenses 220 actually maintained for the associated application 115. The management server 130 may be configured to automatically secure additional licenses 220 to maintain the predicted license count below the actual license count by a predetermined margin. The margin may be changed over time based on the operating history of the license estimator 230. More effective prediction may be associated with a smaller margin.

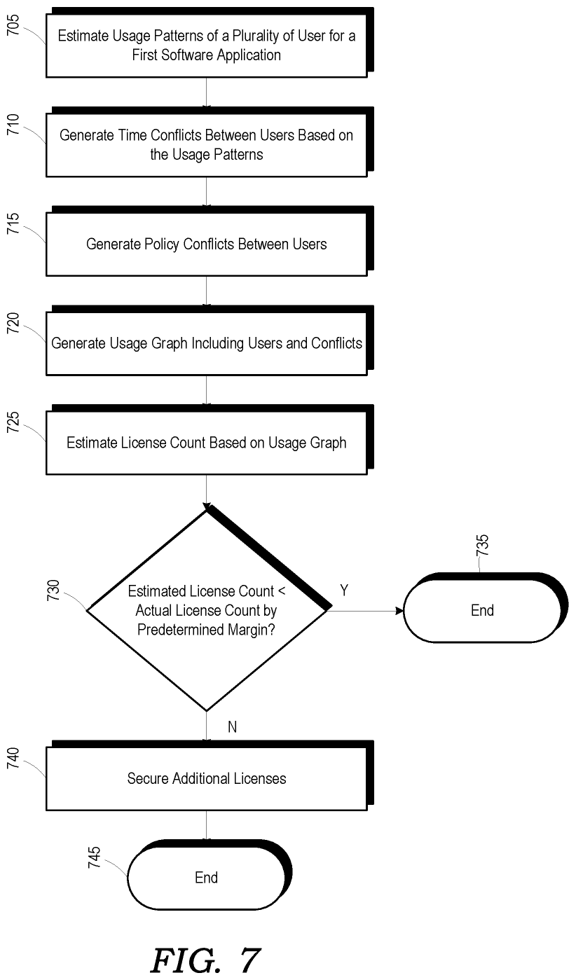

FIG. 7 is a flow diagram of a method 700 for statistical multiplexing of software licenses, in accordance with some embodiments. In method block 705, the usage patterns of a plurality of users for a first application is estimated. The usage patterns may include estimated usage intervals. For “new” users without significant usage history, a persona usage pattern may be employed based on the user's profile and the usage patterns of other users with similar profiles.

In method block 710 time conflicts between users are generated based on the usage patterns (e.g., overlapping usage intervals and time conflicts 405 in FIG. 4).

In method block 715, policy conflicts between the users are generated based on predetermined sharing restrictions. The sharing restrictions may be defined between specific users, classes of users, organizations, etc. (e.g., policy conflicts 410 in FIG. 4).

In method block 720 a usage graph is generated to indicate the users, the time conflicts, and the policy conflicts. The usage graph (see FIGS. 5 and 6) may include a vertex for each user, and the conflicts may be represented by connections between the vertices of the associated users.

In method block 725, a license count is estimated based on the usage graph. In some embodiments, the license count may represent the chromatic number of the usage graph.

In method block 730, the estimated license count is compared to the actual license count of the licenses available for assignment. If the estimated license count is less than the actual license count by a predetermined margin, the number of available licenses should be sufficient to support the requirements of the users and the particular applications, and the method terminates in method block 735.

If the estimated license count is not less than the actual license count by a predetermined margin, the number of available licenses may not be sufficient. In method block 740 additional licenses are secured. In some embodiments, the management server 130 may automatically secure the additional licenses. In other embodiments, the management server 130 may generate an alert message indicating the potential insufficiency of the licenses. The method terminates in method block 745. The method of FIG. 7 may be repeated for each of the applications 115.

If the actual number of licenses were to be insufficient, a particular user would be blocked from using the application 115 at that particular time. By using the license estimator 230 to dynamically predict the required number of licenses, the management server 130 improves the operation of the cloud based virtual computing system 100, ensuring that applications are available to users when required.

A method includes estimating usage patterns of a plurality of users for a first software application in a computing system. A set of time conflicts is generated based on the usage patterns. A license count for the first software application is estimated based on the set of time conflicts. Additional licenses are secured for the first application in the computing system responsive to the estimated license count not being less than an actual license count by a predetermined margin.

A system includes a management server to estimate usage patterns of a plurality of users for a first software application in a computing system, generate a set of time conflicts based on the usage patterns, estimate a license count for the first software application based on the set of time conflicts, secure additional licenses for the first application in the computing system responsive to the estimated license count not being less than an actual license count by a predetermined margin, assign licenses for the first software application to particular users, and prevent operation of the first software application by a selected user responsive to a number of assigned licenses being equal to a maximum allowed number of licenses.

In some embodiments, certain aspects of the techniques described herein may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as flash memory, a cache, random access memory (RAM), or other non-volatile memory devices, and the like. The executable instructions stored on the non-transitory computer readable storage medium may be in source code, assembly language code, object code, or other instruction format that is interpreted or otherwise executable by one or more processors.

A non-transitory computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
estimating usage patterns of a plurality of users for a first software application in a computing system;
generating a set of time conflicts based on the usage patterns;
estimating a license count for the first software application based on the set of time conflicts; and
securing additional licenses for the first application in the computing system responsive to the estimated license count not being less than an actual license count by a predetermined margin.

2. The method of claim 1, further comprising:
generating a set of time policy conflicts associated with license sharing by the plurality of users; and
estimating the license count for the first software application based on the set of time conflicts and the set of policy conflicts.

3. The method of claim 1, wherein estimating the license count comprises:
generating a graph of the plurality of users, wherein each user is represented as a vertex in the graph;
connecting the vertices for selected users associated with the set of time conflicts; and
determining a chromatic number of the graph.

4. The method of claim 1, wherein estimating the usage patterns comprises:
defining a time window;
for each user, evaluating usage history data of the user for the first software application; and
generating a time interval of expected usage for each user.

5. The method of claim 4, further comprising:
defining a set of usage history personas, each usage history persona having an associated set of profile characteristics and associated usage history data;
determining that a particular user has insufficient usage history data;
comparing a profile of the particular user to the set of profile characteristics to identify at least one usage history persona matching the profile; and
generating the time interval of expected usage for the particular user based on the usage history data associated with the identified at least one usage history persona.

6. The method of claim 5, further comprising generating the time interval of expected usage for the particular user based on a combination of the usage history data associated with an identified set of usage history persona matching the profile.

7. The method of claim 5, wherein the profile comprises at least one of job role or experience level.

8. The method of claim 5, wherein the profile comprises degree enrollment data.

9. The method of claim 1, further comprising:
assigning licenses for the first software application to particular users; and
registering the assigned licenses with a license server associated with the first software application.

10. The method of claim 9, further comprising preventing operation of the first software application by a selected user responsive to a number of assigned licenses being equal to a maximum allowed number of licenses.

11. A system, comprising:
a management server to estimate usage patterns of a plurality of users for a first software application in a computing system, generate a set of time conflicts based on the usage patterns, estimate a license count for the first software application based on the set of time conflicts, secure additional licenses for the first application in the computing system responsive to the estimated license count not being less than an actual license count by a predetermined margin, assign licenses for the first software application to particular users, and prevent operation of the first software application by a selected user responsive to a number of assigned licenses being equal to a maximum allowed number of licenses.

12. The system of claim 11, wherein the management server is to generate a set of time policy conflicts associated with license sharing by the plurality of users and estimate the license count for the first software application based on the set of time conflicts and the set of policy conflicts.

13. The system of claim 11, wherein the management server is to estimate the license count by generating a graph of the plurality of users, wherein each user is represented as a vertex in the graph, connect the vertices for selected users associated with the set of time conflicts, and determining a chromatic number of the graph.

14. The system of claim 11, wherein the management server is to estimate the usage patterns by defining a time window, for each user, evaluating usage history data of the user for the first software application, and generating a time interval of expected usage for each user.

15. The system of claim 14, wherein the management server is to define a set of usage history personas, each usage history persona having an associated set of profile characteristics and associated usage history data, determine that a particular user has insufficient usage history data, compare a profile of the particular user to the set of profile characteristics to identify at least one usage history persona matching the profile, and generating the time interval of expected usage for the particular user based on the usage history data associated with the identified at least one usage history persona.

16. The system of claim 15, wherein the management server is to generate the time interval of expected usage for the particular user based on a combination of the usage history data associated with an identified set of usage history persona matching the profile.

17. The system of claim 15, wherein the profile comprises at least one of job role or experience level.

18. The system of claim 15, wherein the profile comprises degree enrollment data.
